(19) United States
(12) Patent Application Publication
(10) Pub. No.: US 2010/0308639 A1
(43) Pub. Date: Dec. 9, 2010

(54) Battery Powered Hauling Car Operated by Remote Control

(76) Inventor: Thomas Scott Cushman, Beckley, WV (US)

Correspondence Address: NIXON & VANDERHYE, PC, 901 NORTH GLEBE ROAD, 11TH FLOOR, ARLINGTON, VA, 22203, US

(21) Appl. No.: 12/796,393

(22) Filed: Jun. 8, 2010

Related U.S. Application Data
(60) Provisional application No. 61/213,432, filed on Jun. 8, 2009.

(51) Int. Cl. B60P 1/00; E21C 35/20; E21C 35/00

(52) U.S. Cl. 299/18; 414/507

(57) ABSTRACT

A hauling system and hauling car for hauling mined materials includes a body defining a storage area for receiving the mined materials, a conveyor positioned in a bottom portion of the storage area, and a motor coupled with the conveyor and driving the conveyor. The motor is controllably operable via a remote control system, and the body includes at least one connector connectable to a winch system that controllably advances and retrieves the hauling car. The use of a winch system for advancing and retrieving the hauling car provides for increased volumetric capacity. Additionally, the structure enables transport of evenly distributed loads and more efficient dumping.

### CROSS-REFERENCES TO RELATED APPLICATIONS

This application claims the benefit of U.S. Provisional Patent Application Ser. No. 61/213,432, filed Jun. 8, 2009, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

This disclosure is directed to an apparatus and method for transporting mined material from the point of mining to a point of discharge. The following patent and patent applications are hereby incorporated by reference: U.S. Pat. Nos. 4,951,801, 6,926,368 and 6,109,699 to Mraz, U.S. Patent Application Publication No. 2004/0134694 to Allen et al. and U.S. Patent Application Publication No. 2004/0251732 to Lowery.

High wall mining is generally a method of mining whereby a remote controlled continuous miner is sent into a face of coal, or other ore, from an outside bench to mine or cut such ore out from under the overburden above. The continuous miner will generally cut out the ore in widths ranging from 6 to 14 feet and up to 20 feet in height, depending on the size of the miner used. As the miner is remotely controlled from the outside into the ore, units for transferring the mined ore, called “cars” or “beams” are sequentially sent into the mine. Such cars may be advanced via a self-propelled mechanism, hydraulic driving system, or a winch system.

Cars typically have either a fixed payload area or a payload area that is lined with a conveyor unit. A fixed payload area results in a car that is not loaded to maximum capacity because the mined material builds up beneath a discharge boom of the continuous miner. The conveyor unit enables the payload area to handle a large capacity and an evenly distributed load. Current cars are manually operated and must be completely removed from a mine to dump its payload. In dumping its payload, cars typically utilize a hydraulic system that will raise the car so as to dump its payload. Alternatively, a car may be incorporated into an extraneous machine that will dump the car's payload.

The above mentioned methods for dumping require a car to be removed from the mine where it may be subjected to the outside environment. While exposed to the outside environment, the car and its associated devices are more susceptible to maintenance issues caused by cold or wet weather.

Another issue with current cars is that self propelled cars have a reduced volumetric capacity when compared to non-self propelled cars. The drive mechanisms in self-propelled cars take up precious cargo space.

### BRIEF SUMMARY OF THE INVENTION

In view of the above shortfalls, it would be advantageous to provide a capability by which a car could be advanced and retrieved utilizing a winch system so that the car has an increased volumetric capacity, transports an evenly distributed load and dumps its payload independent of other devices whether located inside or outside the mines.

There is a need to develop an apparatus and method to allow for the hauling of mined material and the dumping of that mined material remotely such that the car is not required to be lifted by an onboard or off board hydraulic system to dump its payload. This need is based on improving the reliability of mining systems as well as improving the safety of mining operators.

It is desirable to have a mechanism for observing the status of the car while the car is in the mine. It is further desirable to develop a car that is movable on a flat bottom, wheels, skids, crawler tracks, or the like. Any wheels, skids, or crawler tracks may be made of a same material as that of the car or an alternative material such as a metals, polymers or woods. In various exemplary embodiments, the apparatus and method according to this disclosure may provide a capability by which a mining car may be advanced and retrieved into and out of a mine via a winch system. The car may have a plurality of connectors for connecting the car to the winch system such as hooks, loops, holes, quick-release permanent fasteners and the like. The connectors may be positioned at a front end of the car or at many locations to afford easy access or better maneuverability of the car inside the mine. The mining car may also incorporate a conveyor system that may have a single or a dual conveyor motor for driving the system. The conveyor system may receive its power from an onboard battery, plurality of batteries, or a direct connection to an alternative power source. The conveyor may only be actuated upon demand by an activation command from a control unit.

For receiving the activation command, the car may have an onboard receiver that receives a signal from a remote unit that is detached from the car, or the car may have an onboard set of controls for instructing the activation command. The car may also have a sensor such as a camera, scale or other measurement device for determining the status of the car's payload such that the car may remotely communicate this status to a detached receiving unit so that the car may be retrieved by the winch system upon demand. An objective is to make the car dump its payload upon reaching its destination by remote actuation so that the car does not have to be raised by a hydraulic system or other means, such as incorporation to an external machine, to dump its payload.

These and other features and advantages of the disclosed apparatus and method, are described in, or apparent from, the following detailed description of the various exemplary embodiments.

### BRIEF DESCRIPTION OF THE DRAWINGS

Various exemplary embodiments of the disclosed apparatus and method for hauling mined material will be described, in detail, with reference to the following drawings wherein:

FIG. 1 illustrates a top view of a typical hauling car;

FIG. 2 illustrates a top view of the battery powered hauling car;

FIG. 3 illustrates a side view of the battery powered hauling car; and

FIG. 4 illustrates a front view of the battery powered hauling car.

### DETAILED DESCRIPTION OF THE INVENTION

The following embodiments illustrate examples of various apparatuses and methods for hauling of mined material and the dumping of that mined material remotely such that a hauling car is not required to be acted upon by a hydraulic mechanism to dump its payload. It should be appreciated that, although the apparatuses and methods according to this disclosure may be applicable to such a specific application, the depictions and/or descriptions included in this disclosure are not intended to be limited to any specific application. Any apparatus and/or method for hauling mined material that may advantageously apply the apparatus and method described in exemplary manner in this disclosure are contemplated.

Exemplary embodiments of this disclosure may provide apparatuses and methods for hauling and dumping mined material. Examples of hauling means may be that of a hauling car, that may be advanced and retrieved from a mine using a winch system. This disclosure also contemplates remotely controlling the car using an off board control device and powering the car using onboard batteries. The car may, however, be powered through other means such as, for example, a connection to a power line integrated with the winch system.

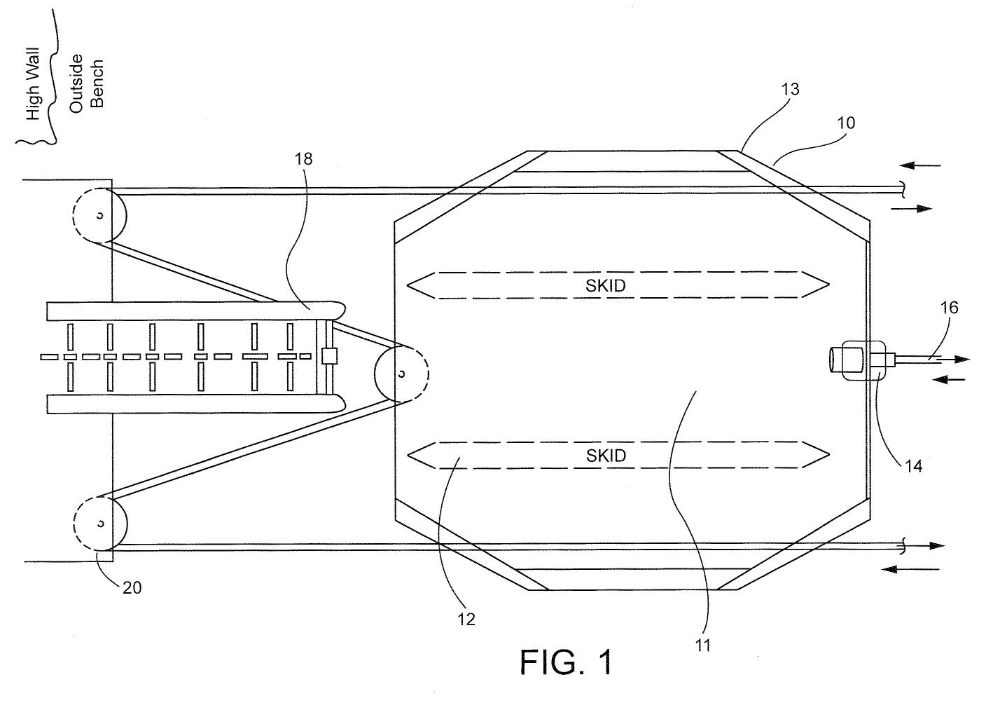

FIG. 1 illustrates a typical coal car 10. The coal car 10 has a body 13 and a storage area 11. The coal car 10 is connected to a winch system 16 via a connector 14. The coal car 10 is positioned near a discharge boom 18 of a continuous miner 20 so that mined material may be dumped into storage area 11 from the discharge boom 18. The coal car 10 is moved on skids 12.

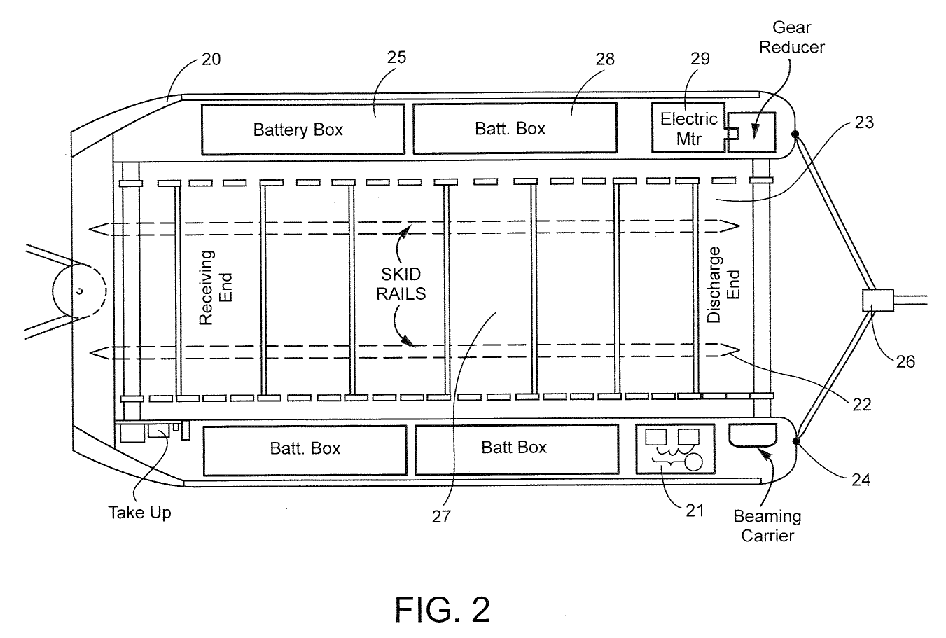

FIG. 2 illustrates a battery operated hauling car 20. The car 20 has a body 25 that may be made of metals, woods, various polymers or any combination thereof. The car 20 has a storage area 27 that has a conveyor 23 at its base. The conveyor 23 allows for the bed of the storage area to move such that mined material loaded from a discharge boom may be evenly distributed and the usable capacity of the car 20 may be increased for each use. The conveyor 23 is driven by an electric motor 29 that is powered by onboard batteries 28. The batteries are actuated on demand from an electronic control box 21 that has onboard controls and also communicates with an off board remote control device. The car 20 is advanced and retrieved by a winch system 26 that is connected to the car 20 via a connector 24. Although various known winch systems may be used, one suitable winch system is disclosed in the above-referenced U.S. Patent Application Publication No. 2004/0251732 to Lowery. When the car 20 is retrieved from the mine by the winch system 26, the car may stay inside the mine and may be unloaded either locally or remotely by activating the conveyor 23 to dump the mined material that is loaded from the discharge boom. However, the coal car would typically be removed from the mine for dumping. The storage area 27 may also have alternative conveyors positioned on the sidewalls of the storage area to further aid in distributing and dumping the mined material.

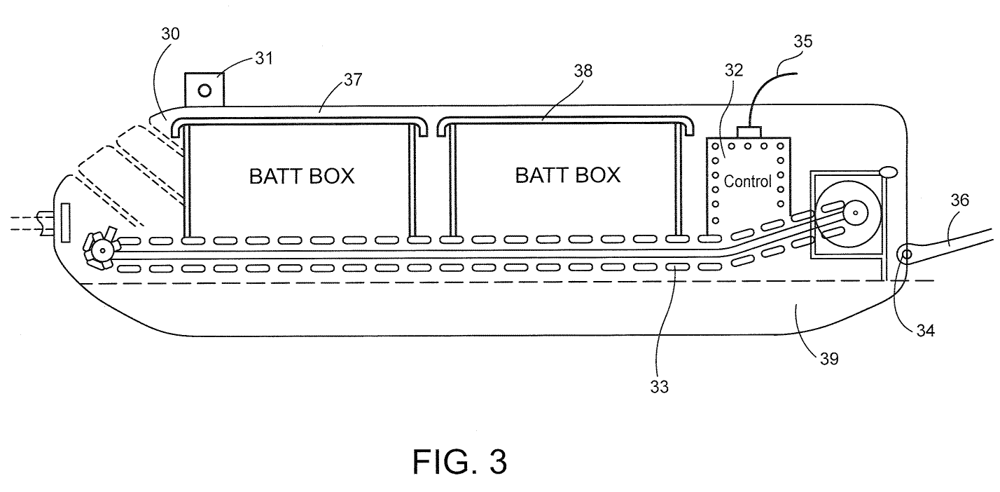

FIG. 3 illustrates a side view of a car 30 having a body 37 that is moved on skid rails 39. The car 30 is connected to a winch system 36 for advancing and retrieving the car 30 by a connector 34. The car 30 has a conveyor 33 at the bottom of its storage area that is powered by onboard batteries 38. The conveyor 33 is actuated on demand by a command sent from the control box 32 that receives a signal via antenna 35. The car also has a camera 31 that communicates with the control box 32 such that a status of the car's payload may be observed.

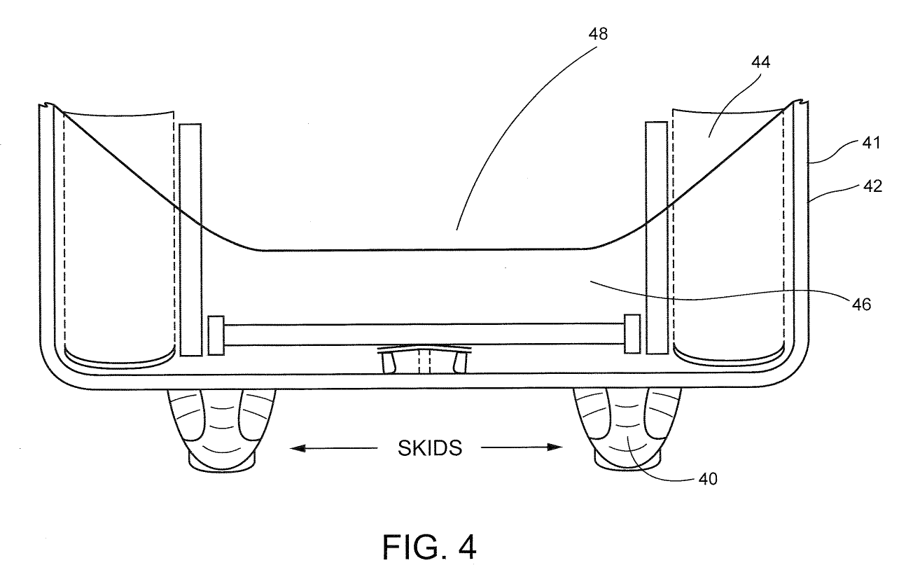

FIG. 4 illustrates a front view of a car 41 having a body 42, a battery storage area 44, a payload storage area 48, a conveyor 46 and skids 40. It should be appreciated that the skids may be replaced with wheels, crawler tracks, or the like, for moving the car. The car may also be movable on a flat or curved bottom. It should further be appreciated that the payload area may handle loads in excess of 20,000 lbs. However, the car may be modified for payload requirements of less than 20,000 lbs.

A method of using the car may be in a manner that the car is connected to a plurality of cars such that the cars may travel in series as a train. The cars may be detachable from one another so that a particular car may stay at the discharge boom while the other cars are unloaded.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A hauling system for hauling mined materials, the hauling system comprising:
a hauling car including:
a body defining a storage area for receiving the mined materials,
a conveyor positioned in a bottom portion of the storage area, and
a motor coupled with the conveyor and driving the conveyor;
a control system remotely communicating with the motor, the control system enabling remote selective operation of the motor; and
a winch system coupled with the hauling car, the winch system controllably advancing and retrieving the hauling car.

2. A hauling system according to claim 1, wherein the hauling car comprises a control box including onboard controls for operation of the hauling car and including communication structure that receives signals from the remote control system.

3. A hauling system according to claim 1, further comprising at least one supplemental conveyor positioned in a sidewall of the storage area.

4. A hauling system according to claim 1, further comprising batteries positioned on the hauling car, the batteries providing electric power to the motor.

5. A hauling system according to claim 1, further comprising a connection to a power line integrated with the winch system, the power line providing electric power to the motor.

6. A hauling system according to claim 1, further comprising skid rails on which the hauling car is supported for movement.

7. A hauling system according to claim 1, further comprising a camera positioned in view of the storage area, the camera supplying images of a payload in the storage area.

8. A hauling system according to claim 1, wherein the hauling car comprises at least one connector coupleable to the winch system.

9. A hauling system according to claim 8, wherein the at least one connector comprises at least one of hooks, loops, holes, quick-release couplings, and fasteners.

10. A hauling system according to claim 8, wherein the at least one connector is disposed at one of a front end of the hauling car, a rear end of the hauling car, and sides of the hauling car.

11. A hauling car for hauling mined materials, the hauling car comprising:
a body defining a storage area for receiving the mined materials;
a conveyor positioned in a bottom portion of the storage area;
a motor coupled with the conveyor and driving the conveyor; and
at least one battery secured to the body and providing electric power to the motor,
wherein the motor is controllably operable via a remote control system, and wherein the body includes at least one connector connectable to a winch system that controllably advances and retrieves the hauling car.

12. A method of hauling mined materials using a hauling car, the hauling car including a body defining a storage area for receiving the mined materials, a conveyor positioned in a bottom portion of the storage area, and a motor coupled with the conveyor and driving the conveyor, the method comprising:
(a) advancing the hauling car to a position adjacent a miner to receive the mined materials from the miner;
(b) receiving the mined materials from the miner at a receiving end of the hauling car;
(c) controlling the motor to drive the conveyor and distribute the mined materials in the storage area; and
(d) retrieving the hauling car via a winch system and controlling the motor to drive the conveyor and dump the mined materials from the storage area.
